(19) United States
(12) Patent Application Publication
(10) Pub. No.: US 2026/0080600 A1
(43) Pub. Date: Mar. 19, 2026

(54) SYSTEM AND METHOD FOR END-TO-END PIPELINE FOR PHOTO-REALISTIC 3D MOTION GENERATION

(71) Applicant: Samsung Electronics Co., Ltd., Gyeonggi-do (KR)

(72) Inventors: Mohammad ASADI, Stanford, CA (US); Menghe ZHANG, San Diego, CA (US); Yangwen LIANG, San Diego, CA (US); Kee-Bong SONG, San Diego, CA (US)

(21) Appl. No.: 19/326,241

(22) Filed: Sep. 11, 2025

Related U.S. Application Data
(60) Provisional application No. 63/694,376, filed on Sep. 13, 2024.

(51) Int. Cl. G06T 13/40; G06T 5/60; G06T 5/70; G06V 40/20

(52) U.S. Cl. CPC G06T 13/40; G06T 5/60; G06T 5/70; G06V 40/20

(57) ABSTRACT

A system and method are disclosed. The method includes receiving a semantic input; encoding gesture or motion data into a latent space using a vector-quantized encoder; generating, within the latent space and based on the semantic input, a latent motion sequence; decoding the latent motion sequence into a three-dimensional motion sequence comprising a plurality of frames; and generating a video based on the three-dimensional motion sequence.

### CROSS-REFERENCE TO RELATED APPLICATION

This application claims the priority benefit under 35 U.S.C. § 119(e) of U.S. Provisional Application No. 63/694,376, filed on Sep. 13, 2024, the entire contents of which are incorporated herein by reference.

### TECHNICAL FIELD

The disclosure generally relates to computer vision, machine learning, human motion synthesis, and photorealistic image synthesis. More particularly, the subject matter disclosed herein relates to improvements to systems and methods for generating semantically meaningful and photo-realistic three-dimensional (3D) hand motion data from one or more high-level inputs such as natural language input(s) or demonstration input(s).

### SUMMARY

Accurately generating realistic hand motion is a longstanding challenge in the fields of computer vision and human-computer interaction. The hand is a highly complex structure, and gestures often involve subtle spatial and temporal variations that are difficult to capture and reproduce. Traditional data-driven methods for generating 3D hand motion typically rely on large-scale real-world motion capture datasets or hand-crafted animation pipelines, which are labor-intensive, limited in gesture diversity, and difficult to scale for downstream applications such as extended reality (XR), human pose estimation, or gesture recognition.

To solve these problems, some approaches have used motion capture systems or synthetic rendering engines to build datasets of hand poses and motions. Real-world capture methods, while realistic, require specialized hardware and manual annotation and are constrained to a limited set of gestures. Synthetic rendering pipelines, on the other hand, when authored manually in a 3D engine, can produce smooth and coherent motion but may not scale, as they often rely on predefined sets of data, and may suffer from poor realism, limited expressiveness, or lack of semantic control over the generated gestures.

One issue with the above approaches is their lack of scalability and flexibility. Real-world datasets cannot easily accommodate novel gestures or adapt to new domains, while synthetic data generation can exhibit reduced temporal coherence or realism. Furthermore, traditional rendering pipelines are not optimized for photorealistic output and often require significant manual tuning to maintain realism and consistency across frames.

To overcome these issues, systems and methods are described herein for generating photo-realistic 3D hand motion sequences using an end-to-end generative pipeline conditioned on high-level inputs. In one aspect, a vector-quantized variational autoencoder (VQ-VAE) may be used to encode hand motion into a discrete latent space tailored to hand dynamics. A diffusion model may then operate within this latent space to generate a new motion sequence conditioned on text input(s) or demonstration input(s), allowing for semantic control and composability. The generated motion may be subsequently translated into photo-realistic video frames using a grid-based rendering technique that uses image-to-image diffusion models such as ControlNet and Stable Diffusion. This grid layout may enforce visual consistency across frames without requiring video modeling.

The above approaches improve on previous methods because they unify motion synthesis and rendering into a scalable, automated framework that supports the generation of semantically meaningful and anatomically plausible dynamic gestures. By operating in a latent space, the system may reduce computational overhead while enabling diverse gesture outputs. The grid-based image rendering approach may ensure temporal coherence and visual realism, making the resulting video data well-suited for downstream training and deployment in gesture-based interfaces or synthetic dataset creation.

According to an aspect of the disclosure, a method includes receiving a semantic input; encoding gesture or motion data into a latent space using a vector-quantized encoder; generating, within the latent space and based on the semantic input, a latent motion sequence; decoding the latent motion sequence into a 3D motion sequence comprising plurality of frames; and generating a video based on the 3D motion sequence.

According to another aspect of the disclosure, a method includes generating a control signal based on a motion sequence comprising a plurality of frames; arranging the control signal into a grid format, wherein a spatial layout of the grid format corresponds to a temporal ordering of the plurality of frames; generating an image arranged in the grid format; extracting the image into one or more video frames based on the grid format; combining the one or more video frames into a temporally ordered video sequence; and rendering the temporally ordered video sequence on a display device.

According to another aspect of the disclosure, an electronic device includes a processor and a memory storing instructions that, when executed by the processor, cause the electronic device to receive a semantic input; encode gesture or motion data into a latent space using a vector-quantized encoder; generate, within the latent space and based on the semantic input, a latent motion sequence; decode the latent motion sequence into a 3D motion sequence comprising a plurality of frames; and generate a video based on the 3D motion sequence.

### BRIEF DESCRIPTION OF THE DRAWING

In the following section, the aspects of the subject matter disclosed herein will be described with reference to exemplary embodiments illustrated in the figures, in which:

FIGS. 1A-1B are block diagrams illustrating an overview of a continuous motion and video generation pipeline, according to various embodiments;

FIG. 2 is a high-level overview of the conditioning and image synthesis process used in video generation, according to an embodiment;

FIG. 3A is a flowchart illustrating a method for generating a motion sequence, according to an embodiment;

FIG. 3B is a flowchart illustrating a method for generating a motion video, according to an embodiment; and

FIG. 4 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Component” as used herein refers to a portion of a system, software element, hardware element, or a combination thereof. A component may be implemented as computer-executable instructions stored in memory and executed by one or more processors, as dedicated circuitry, or as a logical block shown in one or more of the figures.

“Motion sequence” as used herein refers to a temporally ordered series of poses or configurations representing the movement of an object, body part, or structure over time. A motion sequence may correspond to hand motion, facial motion, full-body motion, robotic articulation, or any other deformable or rigid-body movement captured or synthesized across multiple frames. Some examples of “motion sequence” are a sequence of 3D hand poses during a gesture, a series of joint angles in a robotic arm trajectory, or a body movement animation captured using pose parameters.

“Semantic input” as used herein refers to an input signal that conveys intent or instruction that guides the generation or modification of a motion sequence or image content. A semantic input may be provided, for example, as a natural language input or a demonstration input.

“Natural language input” as used herein refers to a semantic input provided in the form of human-readable text that conveys the intent of a desired motion or gesture. A natural language input may include single words, phrases, or sentences that describe an action or pose. When processed by a contrastive language-image pretraining (CLIP) encoder or a comparable text encoder, the natural language input may be embedded into a text embedding that conditions downstream generative components. Some examples of “natural language input” are a prompt such as “pinch,” “wave left,” or “cross fingers,” which may be used to guide latent motion generation or photo-realistic video synthesis. Other terms such as “text prompt” or “language prompt” may also refer to forms of a natural language input.

“Demonstration input” as used herein refers to a semantic input provided in the form of an example gesture that is used to guide motion generation or rendering. A demonstration input may include a single image, a frame, or a temporal clip representing a gesture or portion of motion. When processed by an action encoder or a comparable encoder, the demonstration input may be embedded into a demonstration embedding that conditions downstream generative components. Some examples of “demonstration input” are a still image of a hand pose, a short video clip of a gesture, or a sequence of frames that illustrate a desired motion. Other terms such as “demonstration image,” “demonstration sample,” or “demonstration clip” may refer to forms of a demonstration input.

“Post-processing device” as used herein refers to any component, module, or system that receives one or more outputs of a generative model or rendering pipeline and performs additional operations to modify, refine, or prepare the output for display, playback, or further processing. Some examples of “post-processing device” are a graphical processor that applies smoothing filters to video frames, a temporal alignment module that adjusts frame order, or a transcoding system that converts frame sequences into a playback-ready video file.

“Grid format” as used herein refers to a two-dimensional (2D) arrangement of individual image patches, where each patch corresponds to a temporally distinct frame of a motion sequence or video. The grid format may comprise any number of rows and columns, and may be used to represent a time-ordered sequence spatially across a 2D layout. Some examples of “grid format” are a 3×4 tiled image where each cell represents a different moment in a hand gesture animation, or a 5×5 composite image of depth maps or normal maps corresponding to successive frames of motion.

Various embodiments described herein relate to the fields of computer vision, generative modeling, and human motion synthesis, with particular emphasis on generating photo-realistic 3D hand motion data from high-level user inputs, such as natural language input or demonstration input examples. The disclosed techniques have broad applicability across gesture recognition, XR interaction systems, animation workflows, and robotic control interfaces.

Capturing and replicating dynamic hand motion can be a technically complex task due to the anatomical intricacy of the human hand and subtle semantic nuances that differentiate gesture categories. Within the context of synthetic data generation, conventional approaches often rely on pre-existing datasets or constrained rendering engines, which may limit generalization to previously unseen gestures or expressive motion patterns. Physically based rendering pipelines have been developed to achieve high visual fidelity, but these typically involve multiple manual steps, including character rigging, asset selection, material and lighting configuration, and final rendering, each of which may require substantial time, expertise, and resources to preserve anatomical plausibility and photorealism.

To resolve one or more of these issues, systems and methods are described herein for implementing an end-to-end generative pipeline that synthesizes naturalistic and detailed 3D hand motions from abstract user inputs. One or more embodiments may use latent space modeling to encode and manipulate gesture sequences and apply conditional generative techniques to enable controllable and scalable motion synthesis. The resulting 3D hand motions may be further rendered into photo-realistic video sequences using image-based diffusion models that promote visual consistency across frames. By unifying motion generation and visual synthesis into a modular architecture, the disclosed pipeline may enable efficient and expressive gesture creation while maintaining pose-level accuracy and high-fidelity appearance across a wide range of use cases.

The disclosed system may include multiple integrated components that together enable the generation of semantically meaningful and photo-realistic hand motion video sequences. A latent representation of dynamic hand motion may be obtained using a VQ-VAE, which encodes continuous motion data into a discrete latent space. This discretization facilitates efficient modeling of temporal and structural motion patterns while preserving the expressiveness necessary for realistic gesture synthesis.

In addition, a conditional generative model may operate within this learned latent space. A diffusion-based generative process may be trained to synthesize new sequences of latent codes based on high-level conditioning inputs. The conditioning inputs may be one or more semantic inputs and include natural language input(s) or demonstration input(s), thereby enabling both semantic interpretability and flexible control over the resulting motion sequences. Because the generative process operates in a latent space rather than directly modeling raw motion data, the system supports diverse gesture synthesis while maintaining computational efficiency.

Once the latent motion sequence is decoded back into 3D hand motion parameters, a video synthesis module may render the motion into photo-realistic video. To achieve high visual fidelity and temporal coherence, the rendering process may employ a diffusion-based image-to-image translation model, such as ControlNet or Stable Diffusion. Rather than generating each frame independently, which may lead to temporal inconsistencies, the system may arrange all video frames into a grid format structure and processes the entire grid as a single image. This approach may make use of the spatial coherence of the image-based diffusion model to enforce consistency across frames, mitigating flickering and other common artifacts.

The overall pipeline may be modular, scalable, and dataset-agnostic, allowing it to generalize across a wide range of complex domains (e.g., hand motion domains). By unifying latent motion modeling with photorealistic rendering under semantic control, the system may offer a flexible solution capable of producing high-quality hand motion content for various applications.

Various embodiments disclosed herein provide several technical advantages relative to conventional gesture synthesis and rendering pipelines. By providing a fully end-to-end architecture, the system may reduce or eliminate the need for manual rigging, material assignment, lighting setup, or traditional physically-based rendering steps. This may enable automated generation of photo-realistic hand motion videos with minimal human intervention. Operating within a learned latent motion space and supporting conditioning inputs, such as one or more semantic inputs (e.g., natural language input(s) or demonstration input(s)), the system can synthesize novel gesture sequences that are semantically guided and not constrained to the distribution of any single dataset. The use of diffusion-based image generation may further ensure high-quality visual outputs, with a grid-based rendering layout promoting improved consistency across video frames. The architecture may also be scalable, making it well-suited for the automated creation of synthetic datasets to support downstream applications such as training hand pose estimation or gesture recognition models.

According to an embodiment, the present disclosure may provide an end-to-end pipeline configured to generate photo-realistic 3D hand motion video content from high-level user inputs, such as natural language input(s) or demonstration input(s). The pipeline may be architected to be modular and lightweight, with separately trainable components that support decoupled training and inference across diverse data sources. The overall process may be divided into two principal stages: a motion synthesis pipeline and a video generation pipeline.

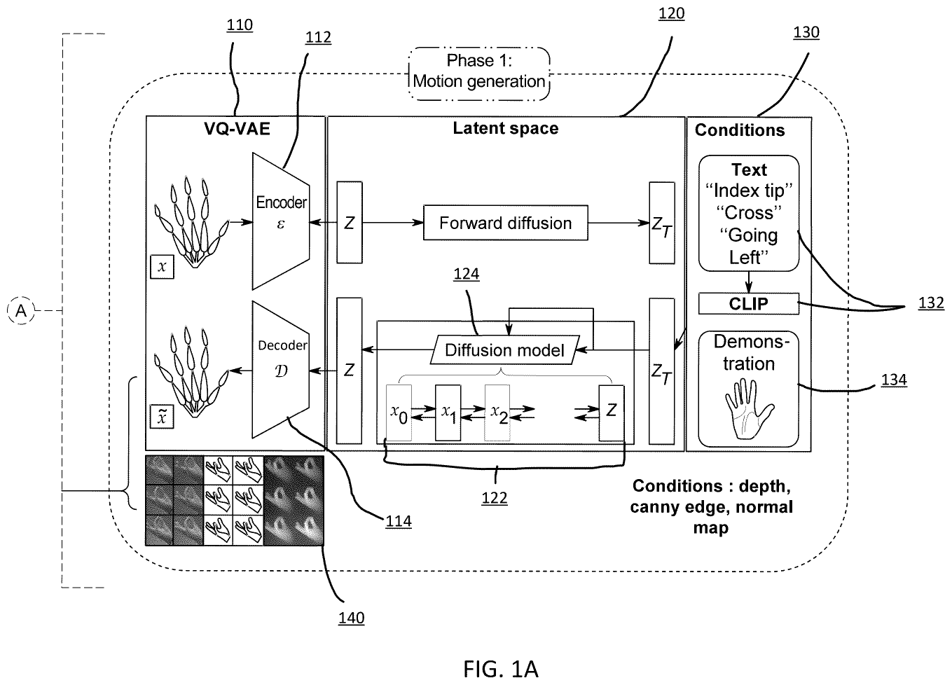

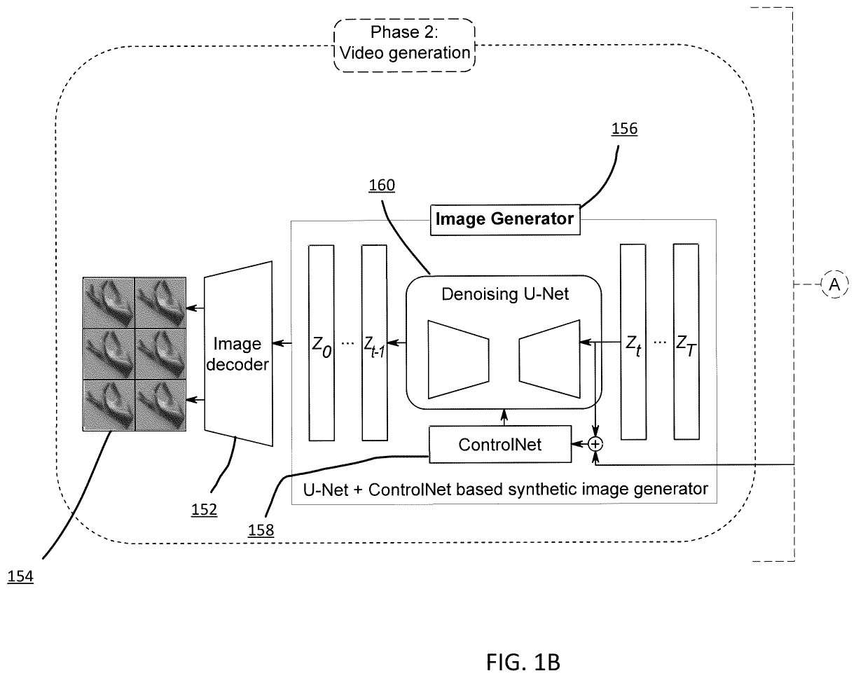

FIGS. 1A-1B are block diagrams illustrating an overview of a continuous motion and video generation pipeline, according to various embodiments.

FIG. 1A and FIG. 1B are a continuous diagram, and are connected by point A, which is on the left side of FIG. 1A, and on the right side of FIG. 1B.

FIG. 1A shows the motion generation pipeline, according to an embodiment. Referring to FIG. 1A, the system may be configured to generate 3D hand motion sequences from high-level user inputs, including natural language input(s) or demonstration input(s). The pipeline 100 may be divided into two principal stages: a latent representation encoding stage using a VQ-VAE, and a conditional latent space diffusion stage using a diffusion model.

In a first stage, a temporal sequence of hand motions may be encoded into a latent space (e.g., gesture or motion data). For example, a VQ-VAE component 110 may be used to convert a temporal sequence of hand poses provided by Equation 1:

$$X = \{ {x}_{1} , {x}_{2} , … , {x}_{T} \} , \qquad Equation l$$

into a compact, discrete latent representation. Each xₜ may correspond to a hand pose at time step t, such as a set of parameters defined by a hand model (e.g., modeling and capturing hand articulations (MANO)). Within VQ-VAE component 110, an encoder component ε 112 may encode the input sequence into a sequence of continuous latent vectors provided by Equation 2:

$$Z = \{ {z}_{1} , {z}_{2} , … , {z}_{{T}^{′}} \} , {z}_{t} ∈ {R}^{d} , \qquad Equation 2$$

where each zₜ∈R^{d}, forming a latent matrix Z∈R^{T′×d}.

The latent vectors zₜ may be quantized to discrete codes [symbol] using a codebook provided by Equation 3:

$$C = \{ {c}_{1} , {c}_{2} , … , {c}_{K} \} \qquad Equation 3$$

where K denotes the number of codebook entries. Each latent vector zₜ may be quantized to its nearest neighbor in a learned codebook as provided by Equation 4:

$$= arg {min}_{{c}_{k} ∈ C} {\vert {z}_{t} - {c}_{k} \vert}_{2} \qquad Equation 4$$

The resulting quantized latent sequence may be provided by Equation 5:

$$\hat{Z} = \{ , , … , \} \qquad Equation 5$$

This sequence may be passed through a decoder component [symbol] 114 to reconstruct the original motion sequence provided by Equation 6:

$$\hat{X} = D ( \hat{Z} ) \qquad Equation 6$$

The VQ-VAE component 110 may be trained using a reconstruction loss provided by Equation 7:

$${ℒ}_{r e c} = {\vert X - \hat{X} \vert}_{2}^{2} \qquad Equation 7$$

and a commitment loss provided by Equation 8:

$${ℒ}_{commit} = {\vert Z - s g [ \hat{Z} ] \vert}_{2}^{2} \qquad Equation 8$$

where sg[⋅] is the stop-gradient operator to prevent gradients from flowing into the quantization step during backpropagation. This representation step ensures that a downstream diffusion model operates on a structured and efficient latent space.

In a second stage, a latent motion sequence may be generated within the latent space conditioned on a conditioning signal c derived from the semantic input. For example, the encoded and quantized latent sequence Z may be provided to a diffusion model 120, and a forward diffusion process 122 may progressively add Gaussian noise to obtain a noisy representation Zₜ provided by Equation 9:

$$q ( {Z}_{t} \vert {Z}_{t - 1} ) = 𝒩 ( {Z}_{t} ; \sqrt{1 - {β}_{t}} {Z}_{t - 1} , {β}_{t} I ) \qquad Equation 9$$

where βₜ is a time-dependent variance schedule controlling the amount of noise at step t.

A transformer-based diffusion generator G, represented within diffusion model 124, may be trained to reverse this noising process. For example, given a noisy latent vector Zₜ, the model may predict the initial clean latent sequence [symbol] provided by Equation 10:

$$= G ( {Z}_{t} , t , c ) \qquad Equation 10$$

where t denotes the diffusion step and c is a conditioning signal obtained from the semantic input (e.g., a text input embedded by encoder 132, or a demonstration input (e.g., a gesture) embedded by encoder 134). Conditioning signal c may be derived from two modalities, as shown in the conditioning component 130: a natural language input encoded via a CLIP-based encoder 132 (e.g., text such as “index tip,” “cross,” or “going left”), or a demonstration input (e.g., a single image, frame or temporal clip) or pose embedded via an action encoder 134. According to one or more embodiments, encoder 132 and/or 134 may be trained to produce embeddings aligned with motion semantics using paired data (e.g., text embeddings that cluster by gesture intent, or demonstration embeddings that reflect motion category or style).

The diffusion model may be trained using a simplified denoising score matching loss provided by Equation 11:

$${ℒ}_{diff} = {E}_{{Z}_{0} ∼ q ( {Z}_{0} \vert C ) , t ∼ [ 1 , T ]} [ {\vert {Z}_{0} - G ( {Z}_{t} , t , c ) \vert}_{2}^{2} ] \qquad Equation 11$$

which encourages accurate recovery of the original latent sequence from its noisy counterpart at each step.

After sampling a new latent sequence [symbol] from the trained diffusion model, the sequence may be decoded by decoder [symbol] 114 to produce the final hand motion output provided by Equation 12:

$$\hat{X} = 𝒟 ( ) \qquad Equation 12$$

Thus, the components of FIG. 1A synthesize a high-quality and temporally coherent hand motion from an abstract user input to ensure semantic fidelity and physical plausibility.

FIG. 1B shows the video generation pipeline, according to an embodiment. Referring to FIG. 1B, the video synthesis pipeline may translate a synthesized 3D hand motion sequence into a temporally coherent, photo-realistic red green blue (RGB) video frames. The pipeline may utilize a diffusion-based image generation technique conditioned on structural control representations rather than relying on physics-based rendering methods.

A latent representation of the 3D motion sequence comprising a set of latent variables z₀, . . . , z_{T-1}, which encode the hand pose information across time may be provided as input to an image decoder 152. The input encoder may produce a tiled RGB image grid 154. Each tile in grid 154 may represent a frame in the gesture sequence, and the 2D arrangement of tiles may correspond to the temporal order of the motion. This layout may provide the model with visibility over the entire gesture sequence, thereby enabling improved consistency across frames through spatial reasoning.

The latent representation that is input to the image decoder 152 may be obtained via a diffusion-based denoising process. Starting from a noisy latent representation z₀, . . . , z_{T-1}, an image generator component 156 may gradually reconstruct the clean latent sequence. As shown in the embodiment of FIG. 1B, the image generator 156 may include, for example, two functional submodules: a ControlNet component 158 and a denoising U-Net 160.

Internally, the system may prepare a set of multi-channel control signals to guide the image generation process. These control signals are shown in FIG. 1A as reference numeral 140, and are computed on a per-frame basis from the synthesized 3D hand pose input and may include a plurality of maps, such as normal maps, edge maps, or depth maps.

A normal map may be generated for each frame to represent surface orientation, with normals calculated directly from the hand mesh geometry to capture local shape details. An edge map may be produced by projecting the hand mesh onto a 2D image plane and extracting silhouette contours, such as through a Canny edge detector. A depth map may also be created by projecting the hand mesh into a virtual camera space and recording per-pixel z-buffer values, which represent the distance of each point on the hand surface from the camera.

The frames may be processed individually, or the control signals (image-based guides derived from 3D motion for conditioning) may be tiled into multiple (e.g., three) corresponding grid images in a grid format, one for each modality (normal, edge, and depth). These three grids may then be stacked and provided as conditioning input (conditioning signal c) to the image generator 156. This spatially structured conditioning may allow the model to learn temporal coherence implicitly, using the continuity across the spatial layout of the grids to maintain visual consistency from frame to frame.

The image generator 156 may be implemented using ControlNet and/or Stable Diffusion to perform image-to-image translation. The stacked control signal grids can drive the synthesis of a single output RGB grid image, laid out in the same format as the input control grids. According to an embodiment, a text embedding derived from the original natural language input may also be included as global conditioning derived from the semantic input. This text embedding may ensure that the generated gesture video aligns semantically with the intended user command (e.g., whether the input was a prompt like “index tip” or “going left”). In some embodiments, the conditioning signal derived from the semantic input may be provided as a global condition to the image generator to maintain semantic alignment between motion and rendered appearance.

After synthesis, the generated RGB grid image may be passed to image decoder 152, which reconstructs the final visual output grid 154. The image may then split into individual frames according to the original tiling pattern. These frames may be chronologically ordered to form the final gesture video. In one or more embodiments, post-processing such as frame-wise smoothing may be applied to further enhance temporal stability, although in many cases, the grid-based synthesis is sufficient to ensure coherence without additional filtering.

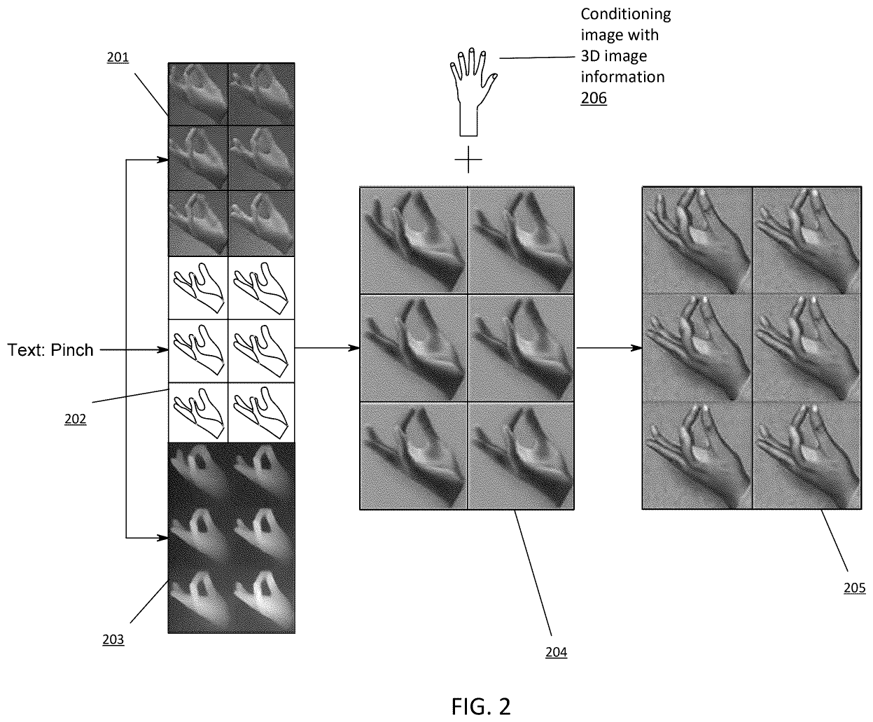

FIG. 2 is a high-level overview of the conditioning and image synthesis process used in video generation, according to an embodiment.

Referring to FIG. 2, the text prompt “Pinch” is shown as an example of a semantic input. The semantic input may be used to generate or guide a corresponding 3D hand motion sequence, which may then be converted into three structured visual control representations. These control representations may include a normal map grid 201, which shows surface orientation and geometric curvature of the hand mesh; an edge map grid 202, which shows the contours of the hand silhouette using a Canny edge detector; a depth map grid 203, which shows distance from the camera for each hand pixel using projected depth information.

These three control representations may be tiled spatially, with all frames laid out in a 2D grid format. This grid format (e.g., a photo grid (the 2D combination of 201, 202, and 203)) may be used as conditioning input to a diffusion-based image synthesis model, such as ControlNet combined with Stable Diffusion. The 2D grid structure may allow the model to observe the entire gesture sequence as a unified spatial object, rather than generating frames independently, thereby helping preserve temporal coherence across the sequence.

The diffusion model may produce a first-stage synthesized RGB image grid 204 based on the photo grid (the 2D combination of 201, 202, and 203) and 3D image information. In the RGB image grid 204, each tile may correspond to a generated video frame. The 3D image information may be used as a style conditioning input to guide skin tone, texture, or rendering style across the synthesized frames.

The final enhanced RGB grid 205 may then be generated, where each frame reflects both the physical hand pose (as informed by the control signal(s) output from 204) and the visual style (as informed by the conditioning image 206 and text prompt). The rendered frames may display realistic lighting, material shading, and fine surface detail, demonstrating how the system achieves photo-realism even for synthetic hand gestures.

According to one or more embodiments, the system may not rely exclusively on a VQ-VAE for motion representation. Other forms of latent encoding may be employed to represent hand motion sequences, including discrete tokenization methods learned from data or continuous latent embeddings produced by variational encoders. Various encoders may provide differing tradeoffs while still supporting downstream generative modeling.

Additionally, the conditional generative model used to synthesize motion within the latent space may also take forms other than a latent diffusion model. For example, transformer-based sequence generation architectures, autoregressive generative models, or score-based generative frameworks may be used to synthesize temporally coherent gesture sequences.

In addition, in the video synthesis stage, other conditioning modalities may be used in place of or in addition to normal maps, edge maps, and depth maps. These may include, for example, ultraviolet (UV) coordinate maps for surface correspondence, optical flow fields for motion dynamics, and/or semantic segmentation masks for region-level structure guidance. Any such representation that provides geometric or structural information about the hand pose could be used to condition the image generation process.

Furthermore, instead of assembling the entire sequence of frames into a single large tiled grid image, the system may process subsets of frames in overlapping temporal windows. This windowed approach may reduce memory requirements while still preserving enough temporal context to maintain visual consistency.

Additionally, the diffusion-based image generator may be replaced or augmented with alternative video synthesis models, such as 3D-aware generative networks that incorporate volumetric information or recurrent diffusion architectures that model temporal dependencies.

Each of these variations remains consistent with the objectives of the disclosed system, which may enable automated, semantically controlled, and/or photo-realistic generation of hand motion sequences using an end-to-end architecture.

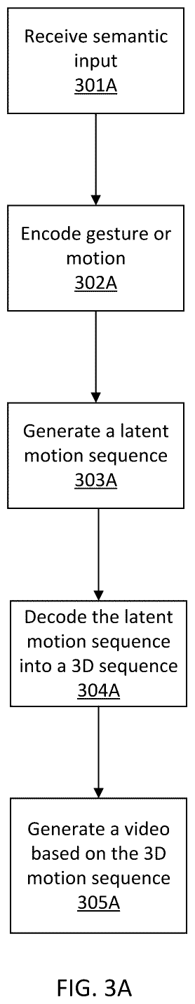

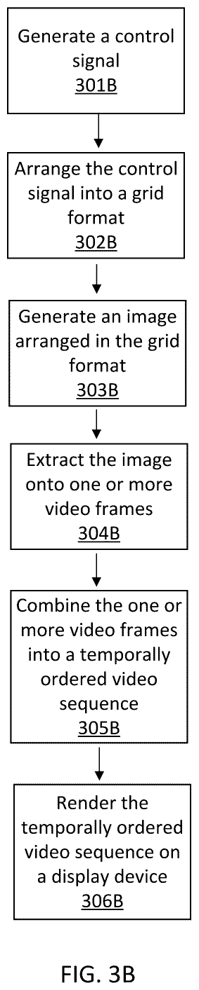

FIG. 3A is a flowchart illustrating a method for generating a motion sequence, according to an embodiment.

The steps of FIG. 3A may be performed by one or more programmable devices, including a desktop or server computer having a central processing unit (CPU) and/or a graphics processing unit (GPU), a mobile device implementing an SoC, or dedicated accelerators such as a neural processing unit (NPU).

Referring to FIG. 3A, in step 301A, a semantic input is received. The semantic input may include a natural language input and/or a demonstration input. This may include, at least one of, a text prompt, a class label, a demonstration trajectory, an audio cue, or parameters supplied via a graphical user interface or application programming interface (API) that specify style, duration, speed, and/or other high-level attributes of a desired motion. The semantic input may be embedded or otherwise transformed into a conditioning signal, which may be provided as a conditioning input suitable for use by downstream generative components.

In step 302A, gesture or motion data is encoded into a latent space using a vector-quantized encoder that may map motion features to discrete codebook indices. The encoder may operate on keypoints, skeletal pose parameters, mesh deformations, or other motion descriptors sampled at a defined frame rate, and may incorporate temporal context via causal or dilated convolutions or based on neighboring frames. The resulting latent sequence can provide a discrete representation of motion dynamics.

In step 303A, a latent motion sequence is generated within the latent space based on the semantic input. For example, a conditional sampler (e.g., diffusion-based or autoregressive) may produce a temporally ordered sequence of latent codes that reflects the semantics, style, and/or duration indicated by the conditioning signal.

In step 304A, the latent motion sequence is decoded into a 3D motion sequence comprising a plurality of frames. The decoder may reconstruct per-frame joint rotations, global translation, and/or optional mesh geometry in a camera coordinate system. The decoded sequence may further include auxiliary channels such as per-frame confidence scores or velocities to facilitate downstream processing.

In step 305A, a video is generated based on the 3D motion sequence. The video may be comprised of a collection of frames in which correction has been performed for temporal smoothing, inverse-kinematics correction, skeletal retargeting, resampling to a target frame rate, and/or packaging into an interchange format for subsequent rendering or control.

FIG. 3B is a flowchart illustrating a method for generating a motion video, according to an embodiment.

The steps of FIG. 3B may be executed on the same device as FIG. 3A or on a separate compute platform such as a GPU-equipped workstation, a game console, a mobile SoC, or a cloud rendering node with hardware video encoders/decoders. A display subsystem may include a monitor, projector, television, or a head-mounted display (HMD), and the rendering pipeline may utilize available graphics APIs and hardware acceleration to generate, extract, combine, and/or present video frames derived from the grid-formatted control signal.

Referring to FIG. 3B, in step 301B, a control signal is generated based on a motion sequence comprising a plurality of frames. The control signal may encode per-frame structure and dynamics and can include, for example, pose keypoints, edge maps, depth, optical flow, segmentation masks, surface normals, and/or other control modalities for conditioning an image-to-image model. The control signal may be normalized and spatially aligned to a common resolution.

In step 302B, the control signal is arranged into a grid format, wherein a spatial layout of the grid corresponds to a temporal ordering of the plurality of frames. The arranging may tile per-frame control representations into collage using a defined traversal order. The grid dimensions may be selected to accommodate a target clip length and aspect ratio while preserving per-tile scale.

In step 303B, an image arranged in the grid format is generated. In one example, an image-to-image diffusion model conditioned on the control grid may produce a photorealistic grid image whose individual tiles correspond to temporally ordered frames.

In step 304B, the image is extracted into one or more video frames based on the grid format. The extraction may segment the grid along tile boundaries, correct for any padding, and produce a set of per-tile frames aligned to the original temporal order. Optional per-frame adjustments (e.g., color normalization) may be applied to reduce tile edge artifacts.

In step 305B, the one or more video frames are combined into a temporally ordered video sequence. The combining may include setting a frame rate, writing frames to a file, and optionally applying temporal stabilization, frame-interpolation, or another parameter to enhance smoothness. Metadata such as timestamps and camera parameters may be embedded for downstream editing.

In step 306B, the temporally ordered video sequence is rendered on a display device. Rendering may involve decoding and presenting frames on a monitor, projector, HMD, or other graphics platform, with hardware acceleration where available. In some embodiments, the sequence may be streamed to a remote device or integrated into an interactive application that plays back the generated motion video.

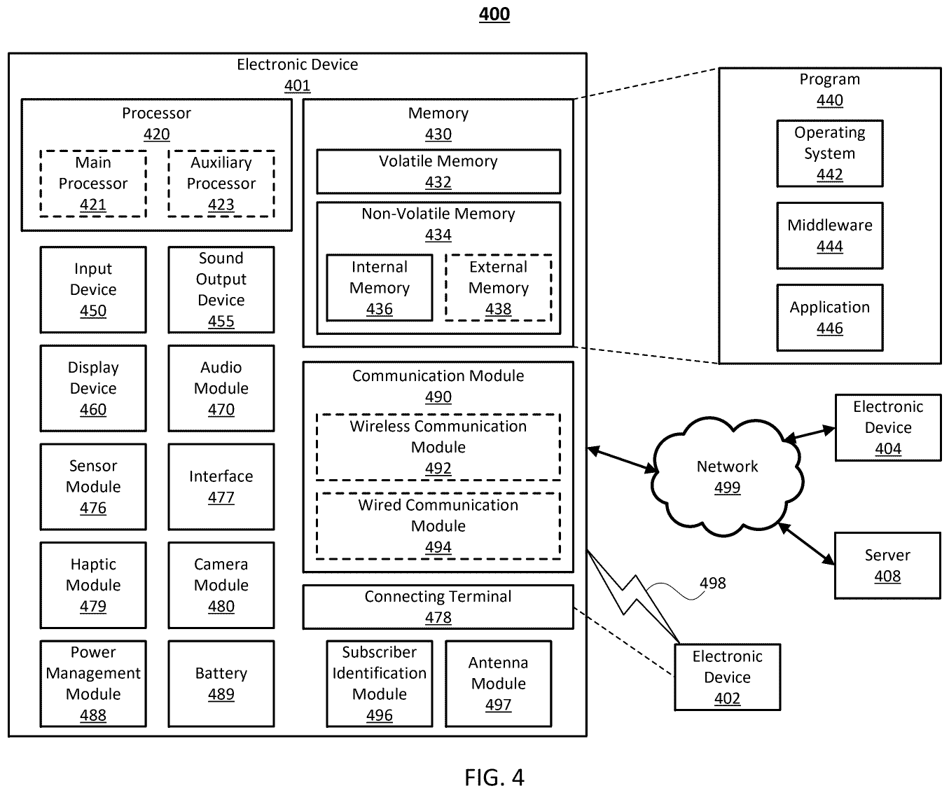

FIG. 4 is a block diagram of an electronic device in a network environment 400, according to an embodiment.

Referring to FIG. 4, an electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include a processor 420, a memory 430, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 497. In one embodiment, at least one (e.g., the display device 460 or the camera module 480) of the components may be omitted from the electronic device 401, or one or more other components may be added to the electronic device 401. Some of the components may be implemented as a single IC. For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 476 or the communication module 490) in volatile memory 432, process the command or the data stored in the volatile memory 432, and store resulting data in non-volatile memory 434. The processor 420 may include a main processor 421 (e.g., a CPU or an application processor (AP)), and an auxiliary processor 423 (e.g., a GPU, an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

Various components of the electronic device 401 may be utilized in implementing the systems and methods described herein for generating photo-realistic 3D hand motion video. In some embodiments, the processor 420, which may include both the main processor 421 and the auxiliary processor 423, executes instructions associated with the hand motion generation pipeline. For instance, the main processor 421 may coordinate the high-level stages of the pipeline, such as parsing a user-provided text prompt or handling demonstration input, while the auxiliary processor 423, such as a GPU or image signal processor, may be responsible for computationally intensive tasks, including encoding hand motion into latent space, executing the denoising steps of the diffusion process, or generating final rendered video frames from control signal grids.

The memory 430, comprising volatile memory 432 and non-volatile memory 434, may be used to store intermediate motion sequences, model weights, control signals (e.g., normal, edge, and depth maps), or synthesized image grids. During operation, intermediate outputs from the VQ-VAE encoder, latent diffusion model, or the image decoder may be held in volatile memory for real-time access by the processor 420, while trained model components or user-specific gesture libraries may be stored in non-volatile memory. The camera module 480 and sensor module 476 may also support one-shot demonstration capture, where a user's hand pose or motion is recorded and used as a conditioning input to the generative pipeline.

In some applications, the generated photo-realistic hand video may be used in XR interactions or gesture-controlled interfaces displayed on the display device 460. The communication module 490 may transmit or receive prompt data, pretrained models, or rendered outputs to or from remote servers 408 via networks 498 or 499. Additionally, the haptic module 479 or audio module 470 may be used in user-feedback applications, such as confirming recognized gestures or enhancing XR experiences.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434. Non-volatile memory 434 may include internal memory 436 and/or external memory 438.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as BLUETOOTH™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
receiving a semantic input;
encoding gesture or motion data into a latent space using a vector-quantized encoder;
generating, within the latent space and based on the semantic input, a latent motion sequence;
decoding the latent motion sequence into a three-dimensional motion sequence comprising a plurality of frames; and
generating a video based on the three-dimensional motion sequence.

2. The method of claim 1, wherein the vector-quantized encoder comprises a codebook to quantize latent vectors.

3. The method of claim 1, wherein the latent motion sequence is generated using a diffusion model to iteratively denoise the latent motion sequence.

4. The method of claim 1, wherein the semantic input is encoded into a text embedding using a contrastive language-image pretraining encoder.

5. The method of claim 1, wherein the semantic input comprises a demonstration input including a single frame or a temporal sequence of pose data.

6. The method of claim 1, further comprising training the diffusion model using a denoising loss computed between a predicted latent value and a reference latent value.

7. The method of claim 1, wherein the latent motion sequence comprises a temporally ordered sequence of discrete latent values corresponding to pose parameters.

8. A method comprising:
generating a control signal based on a motion sequence comprising a plurality of frames;
arranging the control signal into a grid format, wherein a spatial layout of the grid format corresponds to a temporal ordering of the plurality of frames;
generating an image arranged in the grid format;
extracting the image into one or more video frames based on the grid format;
combining the one or more video frames into a temporally ordered video sequence; and
rendering the temporally ordered video sequence on a display device.

9. The method of claim 8, wherein the control signal comprises at least one of a normal map, an edge map, or a depth map for the plurality of frames.

10. The method of claim 8, wherein generating the image comprises applying a diffusion-based image generator based on a ControlNet module or a denoising U-Net module.

11. The method of claim 10, further comprising:
encoding a text prompt, and
providing the text prompt as a conditioning input to the diffusion-based image generator.

12. The method of claim 8, further comprising providing a reference image as an input to control a visual characteristic of the generated image.

13. The method of claim 8, wherein the grid format comprises a two-dimensional arrangement of image regions corresponding to temporally ordered frames.

14. The method of claim 8, further comprising applying post-processing smoothing to the one or more video frames.

15. An electronic device comprising a processor and a memory storing instructions that, when executed by the processor, cause the electronic device to:
receive a semantic input;
encode gesture or motion data into a latent space using a vector-quantized encoder;
generate, within the latent space and based on the semantic input, a latent motion sequence;
decode the latent motion sequence into a three-dimensional motion sequence comprising a plurality of frames; and
generate a video based on the three-dimensional motion sequence.

16. The electronic device of claim 15, wherein the vector-quantized encoder comprises a codebook to quantize latent vectors.

17. The electronic device of claim 15, wherein the latent motion sequence is generated using a diffusion model configured to iteratively denoise the latent motion sequence.

18. The electronic device of claim 15, wherein the semantic input is encoded into a text embedding using a contrastive language-image pretraining encoder.

19. The electronic device of claim 15, wherein the semantic input comprises a demonstration input including a single frame or a temporal sequence of pose data.

20. The electronic device of claim 15, wherein the instructions further cause the electronic device to train the diffusion model using a denoising loss computed between a predicted latent value and a reference latent value.
